(19) United States
(12) Patent Application Publication
(10) Pub. No.: US 2013/0218368 A1
(43) Pub. Date: Aug. 22, 2013

(54) Method for Selecting a Motor Vehicle

(71) Applicants: Michael Kokes, Schriesheim (DE); Bernd Oeffinger, Fellbach (DE)

(72) Inventors: Michael Kokes, Schriesheim (DE); Bernd Oeffinger, Fellbach (DE)

(73) Assignee: Daimler AG, Stuttgart (DE)

(21) Appl. No.: 13/822,360

(22) PCT Filed: Oct. 6, 2011
(86) PCT No.: PCT/EP2011/004987

§ 371 Date: Apr. 9, 2013

(30) Foreign Application Priority Data
Nov. 3, 2010 (DE) 10 2010 050 389.4

(51) Int. Cl. G06F 17/00

(52) U.S. Cl. CPC G06F 17/00
USPC 701/1

(57) ABSTRACT

A method for selecting or configuring a motor vehicle from a plurality of selectable motor vehicles involves providing a motor vehicle database containing a plurality of selectable motor vehicles, each having an associated first load collective data record describing properties of the motor vehicle which can be detected by a sensor system. Technical properties in a comparison vehicle are detected by a sensor system. A second load collective data record is formed by conditioning of the detected technical properties of the comparison vehicle and the two load collective data records are compared. The first load collective data record from the motor vehicle database having the smallest discrepancy from the second load collective data record is determined and the motor vehicle associated with the first load collective data record having the smallest discrepancy is selected.

### BACKGROUND AND SUMMARY OF THE INVENTION

Exemplary embodiments of the present invention concern a method and system for the selection or configuration of a motor vehicle from a set of several possible motor vehicles.

For logistics firms in particular, competition in the road haulage market is increasing, resulting in increasing cost pressures. In order to survive in this market it is ever more important for hauliers competing for customers and market position to distinguish themselves from competitors by the quality of their service, but also through the lowest possible freight costs. Critical cost factors for a vehicle fleet include fuel consumption and fleet maintenance costs. It can often be worthwhile to replace older vehicles with overly high maintenance costs.

For reasons of cost-effectiveness, then, the selection of new vehicles tailored to the actual needs of the haulier is crucial.

German Patent Document DE 103 93 954 T5 discloses a service life indicator for a component of a machine, such service life indicator having at least one sensor associated with the machine during operation and being configured to sense a characteristic associated with the machine and output the sensed characteristic as a data signal. The service life indicator also has a storage element with a first data structure that determines a damage factor for the components of the machine based at least in part on the data signal received by the at least one sensor, as well as a processor to execute the first data structure to determine the damage factor.

The service life indicator provides information on the remaining service life of individual components. Thus, with this information on the actual load spectrum for a particular vehicle, service contracts can be designed to reflect its actual stress situation. The data so obtained is not used to evaluate the driving performance of the driver or the actual stresses on or load spectrum of the vehicle.

It is furthermore known that MAN, the producer of commercial goods vehicles, offers what it calls the “MAN Transporter Efficiency Online Check”. By manually entering the field of operation, distance travelled per year, fuel consumption and number of vehicles, and expected service life, hauliers can receive suggestions concerning additional equipment for their vehicles. A cost comparison is carried out and presented between the current vehicle fleet and the suggested optimised version. Again, actual stresses or load spectra of the vehicles are not used or evaluated. The basic configuration of the existing vehicle fleet also remains unchanged.

Existing vehicle configurators focus almost exclusively on the cost perspective. The question of which vehicle is best suited in terms of its design to the stress profile in its intended field of operation is hardly addressed. Here, too, the aforementioned prior art gives no indication of how one might identify the vehicle technically best suited in terms of its design to the stress situation it will face in use.

Accordingly, exemplary embodiments of the present invention provide a method and a device to enable the vehicle technically best suited for an actual stress situation, including optimally selected additional equipment, to be found or built for a consumer.

Exemplary embodiments of the present invention involve a method for selecting a motor vehicle from among multiple selectable or configurable motor vehicles. Initially a motor vehicle database is provided, containing multiple selectable or configurable motor vehicles each having at least one corresponding data set containing as-designed stress loads, and in particular at least one load spectrum data set, such data set describing ascertainable characteristics of the motor vehicle. This motor vehicle database preferably employs any arbitrary standard database system that may be used for electronic data management and is capable of consistently and permanently storing the saved data sets and providing them upon request. Furthermore, the motor vehicle database may ideally be equipped with storage means in order to store information received.

In addition, a sensor system is used to register the actual technical stresses on a reference vehicle. Among the technical characteristics ideally registered are all stress data that occur, as well as vehicle speed, fuel consumption, drag coefficient (cw value), acceleration and braking values, and maintenance and repair intervals, among others. The sensor system used ideally comprises the SFTP (Supplemental Federal Test Procedure) sensors found in new heavy goods vehicles, which are otherwise used to ensure compliance with federal emissions regulations in the United States. All other sensors already present in the motor vehicle are also advantageous means to register such information. The registering of the technical characteristics of the reference vehicle will also ideally be carried out continuously or repeatedly at predetermined times, or continuously during a predetermined period of time, or repeatedly at predetermined times for a predetermined period of time. In this way, a usage history of the reference vehicle may be generated. Furthermore, the sensor information is preferably obtained by means of polling (cyclical interrogation). The use of interrupt requests or a recursive design is equally feasible.

In particular, the reference vehicle is a motor vehicle that has been used by the customer for an extended period of time. The reference vehicle may ideally be a used vehicle of the customer equipped with a suitable system of sensors. Alternatively, the customer may be provided with a reference vehicle with which the technical characteristics during regular commercial operation can be registered.

The technical characteristics registered and the stresses on the reference vehicle are preferably processed into at least one second field data set, in particular into a load spectrum data set. Ideally, a load spectrum could have one or more load spectra, with load spectrum understood as meaning the statistical evaluation of a stress/time series. As real-world measured strain/time series generally cannot be described mathematically, and several types of information are extraneous, a data reduction is performed with the aid of a suitable counting method. The result of such a count (=classification) is a frequency distribution, i.e. a “collective” of stress characteristics. These collectives thus represent a compression of the stress/time function to the relevant technical characteristics. In particular, the specific counting method suitable for preparing the technical characteristics registered is in each case selected based on the type of technical characteristic registered. For example, such a classification could be a classification according to speed-synchronous time segments, or a rainflow classification.

According to the invention, the two data sets, of design data and field data, are compared. In particular in the event that load spectra are used, the first load spectrum data sets (LK_{KM=x0}) are taken from the motor vehicle database. The comparison may be carried out, for example, by comparing differences between the same type of load spectrum, or by another appropriate method. In particular, at least one load spectrum data set is compared for each motor vehicle that may be selected from the vehicle database. It is not necessary that all load spectra included in the load spectrum data sets be compared.

In general, corresponding data sets for design data and field data may also be compared with one another. In this case, the data sets with the design data are taken from the motor vehicle database. Both the first data sets with the design data as well as the second data sets with the field data may comprise multiple load spectra as well as several other data sets, such as the aforementioned data concerning speed, distance travelled, fuel consumption, wind resistance, etc. In particular, any combination of load spectra and other structures from data sets is possible.

According to the invention, the first data set, and in particular load spectrum data set, is determined that shows the smallest discrepancy relative to the second field data set, in particular the second load spectrum data set. This is the first data set or load spectrum data set having the smallest variance relative to the second field data set or second load spectrum data set.

According to the invention, the motor vehicle or the particular motor vehicle configuration is selected that is allocated to the designated first data set with the lowest discrepancy. This motor vehicle is best suited to fulfil the requirements determined from the actual stress situation established from the reference vehicle.

Ideally, a first data set, in particular a first load spectrum data set, is allocated to a vehicle with a predefined vehicle configuration. The stored first load spectrum data sets thus relate not only to the corresponding vehicles, but also to various different vehicle configurations. In this way, the load spectra are linked with the data of the various possible vehicle configurations, and it is possible to make a statement regarding which vehicle configuration is best suited to fulfil the requirements determined from the actual stress situation established from the reference vehicle.

Ideally, the first and/or second data set or load spectrum data set each contain multiple load spectra. In this way, the load spectrum data sets can accurately represent the actual stress situation of the reference vehicle or the correspondingly allocated vehicles in the vehicle database. Also advantageous is the comparison of a second load spectrum data set with a first load spectrum data set by means of comparing the differences between the same types of load spectrum. For the comparison, differential collectives (LK_{DIFFERENCE}=LK_{KM=x1}−LK_{KM=x0}) are calculated and used. These differential collectives are ideally extrapolated out for the intended service life of the vehicle. This makes it possible for a statement to be made concerning the long-term suitability of the corresponding vehicle for fulfilling the requirements determined from the actual stress situation established from the reference vehicle.

Ideally, variables are assigned to the load spectrum as a measure of vehicle characteristics. Furthermore, it is also possible to convert the load spectrum into simpler key numbers. This permits, for example, persons to select vehicle characteristics with which they are familiar, without requiring detailed knowledge of the load spectrum and their technical implications. The assignment described herein may thus, for example, advantageously simplify interactive communication between a customer and an advisor.

In determining that first data set with design data from the motor vehicle bank having the smallest discrepancy with the second field data set, the individual load spectrum are preferably variably weighted. This weighting permits a greater importance to be given to specific, especially relevant load spectrum in comparing the individual load spectrum. A customer is thus able, for example when speaking with an agent, to choose the load spectrum of greatest importance to him and thus influence the selection of the motor vehicle from the motor vehicle database.

Also advantageously, the second load spectrum data sets and the corresponding reference vehicle are stored in the motor vehicle database. In this way, after each use, the motor vehicle database contains a larger pool of data that can be accessed and retrieved. Future results will be more precise by using this larger pool of data as a basis for comparison.

Ideally, a system or device for the selection of a motor vehicle or for the configuration of a vehicle from among multiple selectable or buildable motor vehicles is provided with a database means for providing a motor vehicle database containing multiple selectable motor vehicles, each having assigned to it a first data set with design data, in particular a first load spectrum data set, describing measurable characteristics of the motor vehicle; a means for registering system data to register technical characteristics of a reference vehicle by means of a sensory system; a means for processing the technical characteristics of the reference vehicle into a second field data set, in particular a second load spectrum data set; a means of comparison for comparing the first and second data set; a means of determination for determining the first data set from the motor vehicle database having the smallest discrepancy with the second data set; and a means of selection for selecting the motor vehicle corresponding with that first data set having the smallest discrepancy.

Ideally, the processing means for processing the technical characteristics registered from the reference vehicle into field data sets, in particular load spectrum, is located in or on the reference vehicle. In particular, the processing of the technical characteristics of the reference vehicles so registered then occurs directly in or on the reference vehicle. In this manner, only the corresponding field data sets, in particular load spectra, and not the complete real-time data registered by the sensor system of the reference vehicle are stored.

In a further possible embodiment, the processing means for processing the technical characteristics registered from the reference vehicle into field data sets, in particular load spectra, is located outside the reference vehicle. Advantageously, the technical characteristics registered by the system data registration means are first cached in a memory located in or on the motor vehicle, then transmitted later to the processing means. Ideally, a transmission interface and corresponding receiving interface are provided, with the transmission interface being located in or on and the receiving interface located outside the motor vehicle, and with the receiving interface configured in such a way that it can transmit data and the receiving interface is configured to receive the data transmitted by the transmission interface. The transmission of the data may be in analog or in digital (parallel or serial) form. Also ideally, the transmission of communications between the transmission interface and the receiving interface is carried out wirelessly, with the communications between the transmission interface and the receiving interface occurring in encrypted form, in that the transmission interface and the receiving interface each have means to encrypt and/or decrypt the data. As an alternative to wireless transmission of the data (e.g. by radio transmission or infrared communication), a fiber optic cable or other medium is also conceivable. All standard encryption methods would be suitable for the encryption of the data.

The device can be designed as a computer system or as a computer network. In the event that the device is furnished as an individual workstation, the individual workstation can be a laptop or notebook. If the device is realised as a computer network, an interface with a company Intranet or to the World Wide Web would be advantageous. In this case, a browser is integrated in the device, and the method according to the invention implemented as a web application in the corresponding network.

### BRIEF DESCRIPTION OF THE DRAWING FIGURES

The invention is described in further detail with the aid of illustrations below. The illustrations represent the following:

FIG. 1 is a schematic representation of the sequence of events of the method, and

FIG. 2 is a schematic representation of the sequence of events of a preferred embodiment of the method for aerodynamic measures.

### DETAILED DESCRIPTION

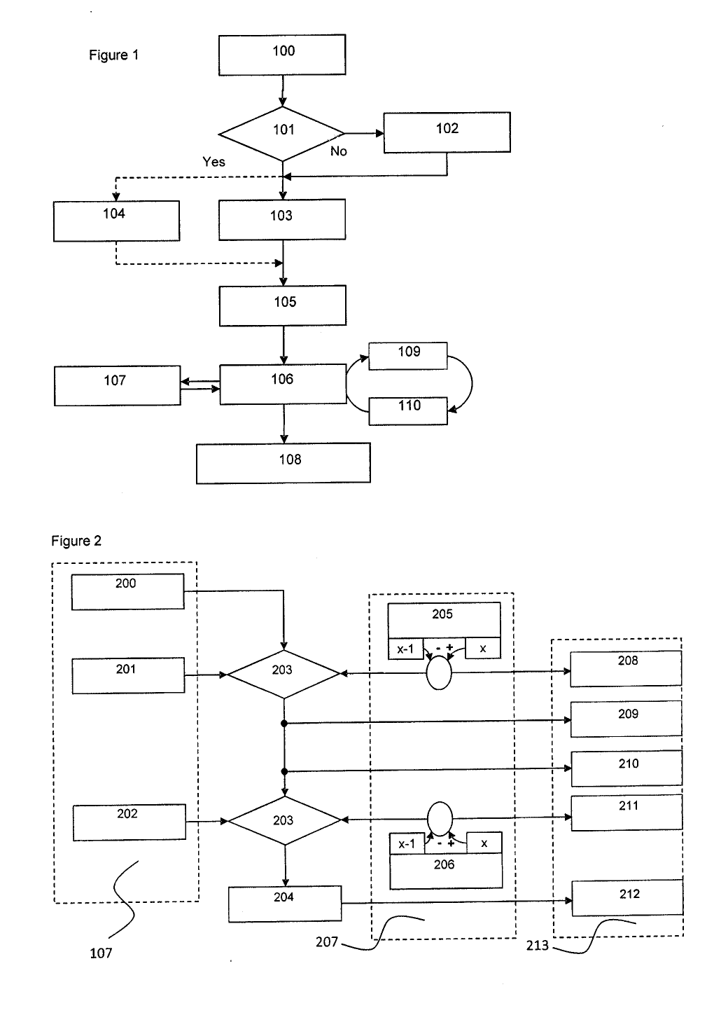

FIG. 1 is a schematic representation of the sequence of events of an exemplary method of the present invention. If, for example, a customer decides to buy a vehicle 100, a distinction is made between whether or not the customer's vehicle fleet contains a suitable reference vehicle 101. A suitable reference vehicle can register the relevant technical characteristics by means of a sensor system. The sensor system can be, for example, the SFTP (Supplemental Federal Test Procedure) sensor set present in new heavy goods vehicles. All other sensors already present in the motor vehicle are also advantageous means to register such information.

If a suitable reference vehicle is available, the characteristics registered or load spectrum data sets are transmitted to a database 103. If no suitable reference vehicle is available, an appropriately suitable vehicle is provided to the customer 102. In the present example, the characteristics registered are transmitted, via a telematics system 104 present in the reference vehicle or directly from the reference vehicle 103, to a database for load spectrum 105. This second load spectrum data set is then compared with the first load spectrum data sets stored in the motor vehicle database 107, and that first load spectrum data set determined which exhibits the smallest discrepancy with the second load spectrum data set 106. In an interactive process between a customer 109 and an advisor 110, the individual load spectra are weighted according to the customer's wishes. In this way, individual load spectra of particular relevance to the customer may be assigned an increased significance when comparing the individual load spectra. The result influenced in this manner, i.e. the motor vehicle corresponding with the first load spectrum data set having the smallest discrepancy when the weighted load spectra are taken into account, is then outputted 108.

FIG. 2 is a schematic representation of the sequence of events of a preferred embodiment of the method for aerodynamic measures described. First depicted is the motor vehicle database 107, in which are stored, among others, the “cw equipment” 200, the fuel price 202, as well as other motor vehicle data (A, %, η) 201. The difference load spectra velocity 208, aerovelocity 209, fuel consumption 210, distance travelled 211, and amortization period 212 are also stored. These difference load spectra are summarized in a “customer monitor” 213; thus, the customer can use them in reaching a decision. The difference load spectra are calculated with the aid of the data 200, 201, 202 from motor vehicle database 107 and load spectrum data 205, 206. The load spectrum velocity 205 and distance travelled were selected by way of example. The amortisation period 204 relevant for a customer's decision is calculated from the fuel price 202 and the other relevant variables, such as e.g. the fuel consumption.

Other first and second data sets could be design data and field data with wear data or vehicle usage data. In particular, these might be data sets concerning brake wear, gearbox wear, wheel bearing wear, motor stress, weight of cargo load transported, ambient temperatures, hours of operation, etc. These data sets can be structured as load spectra or as structured data sets of any other sort.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-13. (canceled)

14. A method for selecting or configuring motor vehicle from among multiple selectable or buildable motor vehicles, the method comprising:
providing a motor vehicle database containing multiple selectable motor vehicles each having at least one corresponding first load spectrum data set describing measurable characteristics of the motor vehicle;
registering technical characteristics in a reference vehicle using a system of sensors;
processing the registered technical characteristics of the reference vehicle to generate a second load spectrum data set;
comparing the first and second load spectrum data sets;
determining a first load spectrum data set having a smallest discrepancy with the second load spectrum data set; and
determining a motor vehicle corresponding with the first load spectrum data set having the smallest discrepancy with the second load spectrum data set.

15. The method according to claim 14, wherein the first load spectrum data set is allocated to a vehicle with a predefined vehicle configuration.

16. The method according to claim 14, wherein the first and second load spectrum data set each contain multiple load spectra.

17. The method according to claim 14, wherein the first data set contains design data for configurable or selectable vehicles and the second data set contains stress data or wear data.

18. The method according to claim 14, wherein the comparison of the second load spectrum data set with the first load spectrum data set is performed by establishing a difference between corresponding load spectra.

19. The method according to claim 18, wherein the load spectra are allocated variables as a measure of vehicle characteristics.

20. The method according to claim 14, wherein when determining the first load spectrum data set exhibiting the smallest discrepancy with regard to the second load spectrum data set, load spectra are variably weighted.

21. The method according to claim 14, wherein the second load spectrum data sets and the corresponding reference vehicle are stored in the motor vehicle database.

22. A device for the selection or configuration of a motor vehicle from among multiple selectable or buildable motor vehicles, said device comprising
a database for provision of a motor vehicle database containing multiple selectable or configurable motor vehicles each having a corresponding first load spectrum data set describing measurable characteristics of the motor vehicle;
means for registering system data to register technical characteristics of a reference vehicle by means of a sensory system,
means for processing the technical characteristics obtained from the reference vehicle into a second load spectrum data set;
means for comparing the first and second load spectrum data sets;
means for determining a first load spectrum data set having a smallest discrepancy with the second load spectrum data set; and
means for determining a motor vehicle corresponding with the first load spectrum data set having the smallest discrepancy with the second load spectrum data set.

23. The device according to claim 22, wherein the processing means for processing the technical characteristics registered from the reference vehicle into load spectra are located in or on the reference vehicle.

24. The device according to claim 22, wherein the processing means for processing the technical characteristics registered from the reference vehicle into the load spectra are located outside the reference vehicle.

25. The device according to claim 22, wherein the device is a single laptop or notebook.

26. The device according to claim 22, wherein the device is network of workstations.
